(19) United States
(12) Patent Application Publication
(10) Pub. No.: US 2005/0227606 A1
(43) Pub. Date: Oct. 13, 2005

(54) Vehicle air conditioning system having air conditioning case

(75) Inventor: Hiroyasu Oide, Obu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/103,411

(22) Filed: Apr. 11, 2005

(30) Foreign Application Priority Data
Apr. 12, 2004 (JP) 2004-117142
Mar. 25, 2005 (JP) 2005-089315

(51) Int. Cl. B60H 1/00; B61D 27/00

(52) U.S. Cl. 454/108

(57) ABSTRACT

In a vehicle air conditioning system, an air conditioning case has a face side opening and a foot side opening. Two slide doors are driven by a single motor through gears to open and close the face side opening and the foot side opening and thereby to establish one of a bi-level discharge mode, a face side discharge mode and a foot side discharge mode of the vehicle air conditioning system.

### CROSS REFERENCE TO RELATED APPLICATION

This application is based on and incorporates herein by reference Japanese Patent Application No. 2004-117142 filed on Apr. 12, 2004 and Japanese Patent Application No. 2005-89315 filed on Mar. 25, 2005.

### BACKGROUND OF THE INVENTION

1. Field of the Invention

The present invention relates to a vehicle air conditioning system, in which openings of an air conditioning case are opened and closed by corresponding slide doors.

2. Description of Related Art

Japanese Unexamined Patent Publication No. 11-254944 discloses a vehicle air conditioning system. In this vehicle air conditioning system, a face side opening, which is connected to a face side discharge opening, and a foot side opening, which is connected to a foot side discharge opening, are arranged adjacent to each other in an air conditioning case and are opened and closed by a single slide door.

In the above vehicle air conditioning system, for example, as shown in FIG. 13, at the time of operating the air conditioning system in a bi-level mode, in which the air is discharged from both of the face side opening 21 and the foot side opening 22, the face side opening 21 and the foot side opening 22 are opened at the opposed ends of the single slide door 930. Thus, the low temperature air, which has been cooled by the evaporator 12, tends to flow into the face side opening 21, and the high temperature air (warm air), which has been heated by the heater core 13, tends to flow into the foot side opening 22. Therefore, in some cases, the temperature difference between the air, which passes the face side opening 21, and the air, which passes the foot side opening 22, becomes excessively large.

To address such a disadvantage, two slide doors, each of which is sized about one half of a size of the opening 21, 22, may be individually slid to open and close the openings 21, 22. However, in general, when the multiple slide doors need to be individually slid, multiple actuators (multiple drive means) are required. This may cause an increase in the manufacturing costs.

### SUMMARY OF THE INVENTION

The present invention addresses the above disadvantages. Thus, it is an objective of the present invention to provide a vehicle air conditioning system, in which multiple slide doors are individually slid by a single drive means.

To achieve the objective of the present invention, there is provided a vehicle air conditioning system, which includes a case, a plurality of slide doors, a plurality of driven side cylindrical gears, a plurality of link means, a driving side gear and a drive means. The case defines an air passage therein and includes a plurality of openings for conducting air. The slide doors open and close the plurality of openings. The driven side cylindrical gears have a common rotational axis and are provided to the plurality of slide doors, respectively. Each of the plurality of driven side cylindrical gears includes a notched portion in a predetermined outer peripheral part thereof. Each of the plurality of link means transmits rotation of a corresponding one of the plurality of driven side cylindrical gears to a corresponding one of the plurality of slide doors. The driving side gear includes a plurality of sections, which correspond to the plurality of driven side cylindrical gears, respectively. Each of the plurality of sections includes a toothed portion and a rib portion. The toothed portion is meshed with the toothed portion of the corresponding one of the plurality of driven side cylindrical gears. The rib portion is engageable with the notched portion of the corresponding one of the plurality of driven side cylindrical gears. The drive means is for driving the driving side gear.

To achieve the objective of the present invention, there is also provided, a vehicle air conditioning system, which includes a case, a plurality of slide doors, a single drive means and a plurality of drive force transmission paths. The case defines an air passage therein and includes a plurality of openings for conducting air. The slide doors open and close the plurality of openings. The single drive means is for driving the plurality of slide doors. The drive force transmission paths transmit a drive force from the single drive means and slide the plurality of slide doors. The plurality of drive force transmission paths includes a driving side link means and a plurality of driven side link means. The driving side link means is connected to and is driven by the single drive means. The multiple driven side link means are driven by the driving side link means and slide the plurality of slide doors, respectively. The driving side link means includes a plurality of drive force transmitting portions, which transmit the drive force to the plurality of driven side link means, respectively. When the single drive means is driven, the plurality of drive force transmitting portions drives the plurality of driven side link means, respectively, so that each of the plurality of slide doors is slide to a corresponding position.

### BRIEF DESCRIPTION OF THE DRAWINGS

The invention, together with additional objectives, features and advantages thereof, will be best understood from the following description, the appended claims and the accompanying drawings in which:

FIG. 1 is a longitudinal cross sectional view showing a schematic structure of a portion of a passenger compartment unit of a vehicle air conditioning system according to an embodiment of the present invention;

FIG. 2 is a cross sectional view taken along line II-II in FIG. 1;

FIG. 3 is a perspective view showing a structure of a slide door;

FIG. 4A is a front view showing a door shaft;

FIG. 4B is a cross sectional view taken along line IVB-IVB in FIG. 4A;

FIG. 5A is a front view showing another door shaft;

FIG. 5B is a cross sectional view taken along line VB-VB in FIG. 5A;

FIG. 6A is a plan view showing a driving side gear;

FIG. 6B is a bottom view of the driving side gear shown in FIG. 6A;

FIG. 7A is a schematic diagram showing engagement between the driving side gear and driven side cylindrical gears in a face side discharge mode;

FIG. 7B is a schematic diagram showing an operational state of first and second slide doors in the face side discharge mode;

FIG. 8A is a schematic diagram showing engagement between the driving side gear and the driven side cylindrical gears in a bi-level discharge mode;

FIG. 8B is a schematic diagram showing an operational state of the first and second slide doors in the bi-level discharge mode;

FIG. 9A is a schematic diagram showing engagement between the driving side gear and the driven side cylindrical gears in a foot side discharge mode;

FIG. 9B is a schematic diagram showing an operational state of the first and second slide doors in the foot side discharge mode;

FIG. 10 is a schematic diagram showing engagement between a driving side gear and driven side gears in a modification of the embodiment;

FIG. 11 is a cross sectional view showing structures of slide doors in another modification of the embodiment;

FIG. 12 is a cross sectional view showing structures of slide doors in another modification of the embodiment; and

FIG. 13 is a cross sectional view of a prior art air conditioning unit having a slide door placed in a bi-level discharge mode.

### DETAILED DESCRIPTION OF THE INVENTION

An embodiment of the present invention will be described with reference to the accompanying drawings.

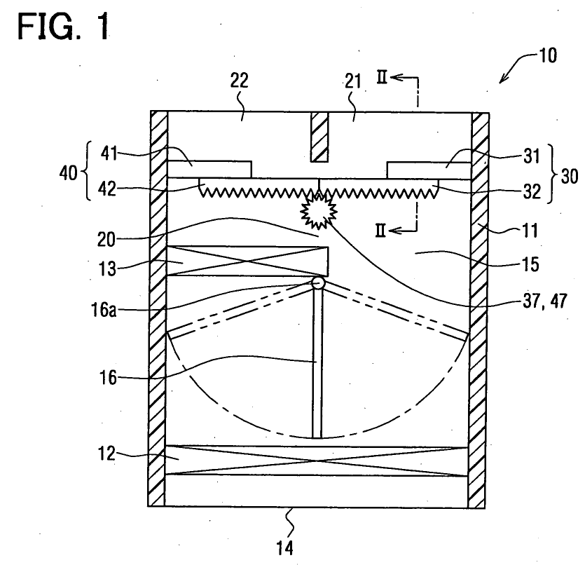

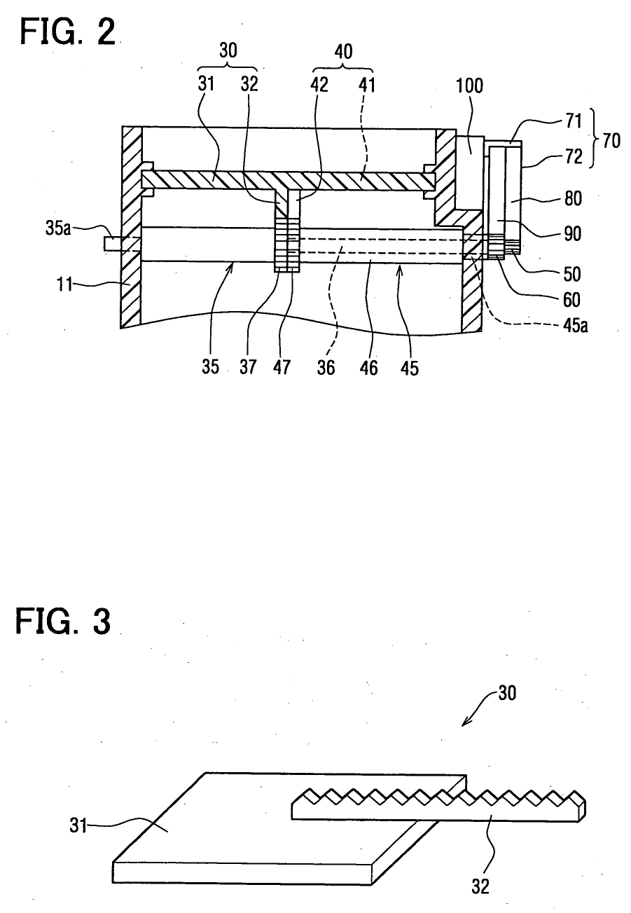

FIG. 1 is a longitudinal cross sectional view showing a general structure of an air conditioning unit of a passenger compartment unit of a vehicle air conditioning system according to an embodiment of the present invention. FIG. 2 is a cross sectional view along line II-II in FIG. 1.

The vehicle air conditioning system of the present invention corresponds to a rear passenger seat air conditioning system for air conditioning a rear seat side space of a relatively large passenger compartment of, for example, a van vehicle.

A draft system of the vehicle air conditioning system of the present embodiment is arranged near a passenger compartment floor at a vehicle rear side between a vehicle outer wall and a vehicle inner wall. The draft system includes an air conditioning unit 10 and a blower unit (not shown), which are arranged in parallel.

The blower unit (not shown) includes a blower for blowing a passenger compartment air, as is well known. In the blower, a known centrifugal multi-blade fan (e.g., a sirocco fan) is rotated by an electric motor.

The air conditioning unit 10 is of a type that includes an evaporator (a cooling heat exchanger) 12 and a heater core (a heating heat exchanger) 13, which are received in a common air conditioning case (a case of the present invention) 11.

The air conditioning case 11 is a molded resin product that is made of a resin material, such as polypropylene, which exhibits resiliency and mechanical strength. Furthermore, the air conditioning case 11 includes a plurality of case sub-parts, which are formed separately. The case sub-parts are integrally connected together by a connecting means (e.g., metal spring clips or screws) to form the air conditioning case 11 after receiving the heat exchangers 12, 13 and other components, such as slide doors described below.

An air flow inlet 14 is provided at the lowest part of the air conditioning case 11 to receive air, which is blown by the blower unit.

In the air conditioning case 11, the evaporator 12 is arranged across the entire air passage at a location, which is right after the air flow inlet 14 on the downstream side of the air flow inlet 14. As is well known in the art, the evaporator 12 takes the latent heat of vaporization of refrigerant of a refrigeration cycle from the air to cool the air.

The heater core 13 is arranged on the downstream side (on the vehicle top side) of the evaporator 12 in such a manner that a predetermined space is provided between the evaporator 12 and the heater core 13. The heater core 13 reheats low temperature air, which has passed through the evaporator 12. More specifically, high temperature engine coolant (high temperature fluid) flows in the heater core 13, and the air is heated by the coolant, which serves as a heat source.

In the air conditioning case 11, a low temperature air bypass passage 15 is formed on the right side of the heater core 13, as shown in FIG. 1. The low temperature air bypass passage 15 is a bypass passage, which bypasses the heater core 13 and conducts the air (the low temperature air). An air mix door 16 is arranged in the vehicle lower side on the right side of the heater core 13 in FIG. 1. The air mix door 15 adjusts a flow ratio between the air (the high temperature air), which passes the heater core 13, and the air (the low temperature air), which passes the low temperature air bypass passage 15.

The air mix door 16 is shaped into a plate form and is connected integrally to a rotatable shaft 16a, which is arranged to extend in a horizontal direction (i.e., a direction perpendicular to a plane of FIG. 1). The air mix door 16 is rotatable together with the rotatable shaft 16a in the left-right direction in FIG. 1.

A low temperature air/high temperature air mixing space 20 is arranged on the downstream side (the vehicle top side) of the heater core 13 and of the low temperature air bypass passage 15. More specifically, the low temperature air supplied from the low temperature air bypass passage 15 and the high temperature air supplied from the heater core 13 are merged in the low temperature air/high temperature mixing space 20 to mix the low temperature air and the high temperature air.

A face side opening 21 opens in the top of the air conditioning case 11 on the right side of FIG. 1. The temperature controlled air, which is outputted from the low temperature air/high temperature air mixing space 20, is supplied to the face side opening 21. The face side opening 21 is connected to a rear seat face side discharge opening through a face side duct (not shown) to discharge the air toward a head of a passenger in a rear seat of the passenger compartment from the rear seat face side discharge opening.

A foot side opening 22 opens in the top of the air conditioning case 11 next to the face side opening 21 on the left side of the face side opening 21 in FIG. 1. The temperature controlled air, which is outputted from the low temperature air/high temperature air mixing space 20, is also supplied to the foot side opening 22. The foot side opening 22 is connected to a rear seat foot side discharge opening through a foot side duct (not shown) to discharge the air toward feet of the passenger in the rear seat of the passenger compartment from the rear seat foot side discharge opening.

The face side opening 21 and the foot side opening 22 are opened and closed by the two slide doors (a first slide door 30 and a second slide door 40), respectively. The face side opening 21 and the foot side opening 22 serve as openings of the case of the present invention.

As shown in FIG. 2, the first slide door 30 and the second slide door 40 are driven to slide by a servomotor 100, which serves as a common (single) drive means, through door shafts (shaft members) 35, 45 and a driving side gear 70.

FIG. 3 is a perspective view showing the first slide door 30. In FIG. 3, a depicted top side of the first slide door 30 becomes a bottom side of the first slide door 30 at the time of installing the first slide door 30 in the air conditioning unit 10. In the present embodiment, the first slide door 30 and the second slide door 40 are of the same type. Thus, description of the structure of the second slide door 40 is omitted for the sake of simplicity.

As shown in FIG. 3, the first slide door 30 includes a door portion 31 and a rack portion (or simply referred to as a rack) 32. The door portion 31 is shaped into a plate form, and a linear gear is formed in the rack portion 32. Although not depicted in detail, the door portion 31 is formed of a resin frame body covered with a film member. The frame body of the door portion 31 is made of a resin material (polybutylene terephthalate in the present case). The rack portion 32 is formed integrally in the frame body of the door portion 31.

The face side opening 21 and the foot side opening 22 are configured to have a rectangular cross section of generally the same type. The door portion 31 is also configured to have a rectangular shape. A width of the door portion 31, which is measured in an extending direction of the rack portion 32, is about one half of the width of the face side opening 21 or the width of the foot side opening 22. That is, a sum of a surface area (e.g., a top surface area in FIG. 1) of the door portion 31 of the first slide door 30 and a surface area (e.g., a top surface area in FIG. 1) of the door portion 41 of the second slide door 40 is generally the same as a cross sectional area of each opening 21, 22. Thus, when the doors 31, 41 are arranged adjacent to one of the openings 21, 22, the doors 31, 41 can fully close the one of the openings 21, 22.

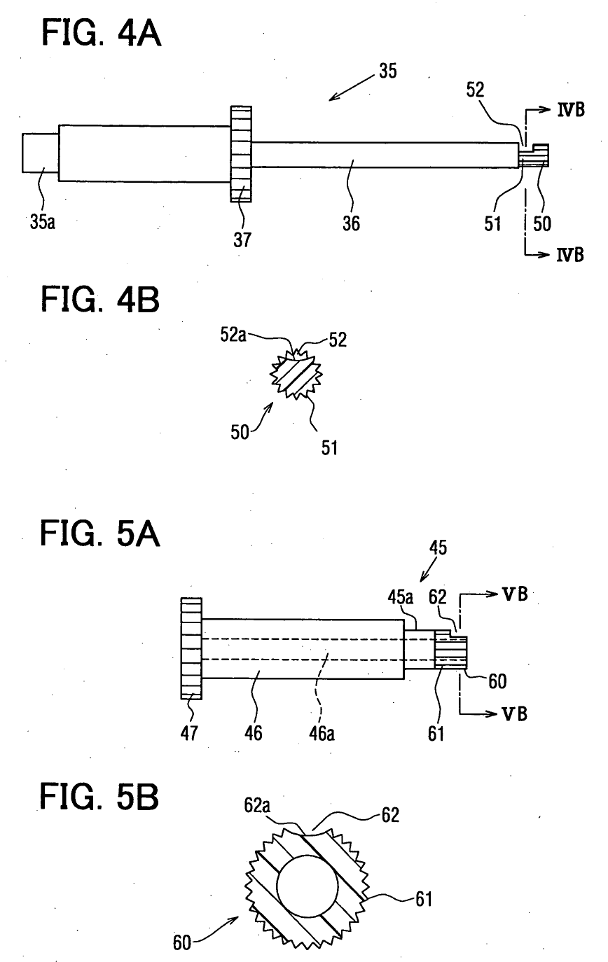

FIGS. 4A and 4B show the door shaft 35 made of a resin material (polyacetal resin in the present case). More specifically, FIG. 4A is a front view of the door shaft 35, and FIG. 4B is a cross sectional view taken along line IVB-IVB in FIG. 4A. FIGS. 5A and 5B show the door shaft 45 made of a resin material (polyacetal resin in the present case like in the case of the door shaft 35). More specifically, FIG. 5A is a front view of the door shaft 45, and FIG. 5B is a cross sectional view taken along line VB-VB in FIG. 5A.

As shown in FIG. 4A, the door shaft 35 includes a cylindrical shaft portion 36. A gear 37 is provided in the left end of the shaft portion 36 in FIG. 4A to mesh with the rack portion 32 of the first slide door 30. An extended portion extends significantly from the gear 37 on the left side of the gear 37 and forms a support end 35a, which is rotatably supported by the air conditioning case 11, as shown in FIG. 2.

A driven side cylindrical gear 50 is formed integrally in the right end of the shaft portion 36 in FIG. 4A. The driven side cylindrical gear 50 includes a toothed portion 51, which includes a plurality of teeth and is meshed with the driving side gear 70. A notched portion 52 is formed in a predetermined axial extent (generally the left half extent in FIG. 4A in the present case) of a predetermined outer peripheral part of the driven side cylindrical gear 50. As shown in FIG. 4B, the notched portion 52 is in a form of an arcuate recess, which is recessed in the outer peripheral part of the driven side cylindrical gear 50 toward the rotational axis (the center) of the driven side cylindrical gear 50. A bottom surface of the notched portion 52 forms an arcuate surface 52a.

As shown in FIG. 5A, the door shaft 45 includes a cylindrical shaft portion 46, though which a through hole 46a penetrates in the axial direction. A gear 47, which is meshed with the rack 42 of the second slide door 40, is provided in the left end of the shaft portion 46 in FIG. 5A.

A driven side cylindrical gear 60 is formed integrally in the right end of the shaft portion 46 in FIG. 5A. The driven side cylindrical gear 60 includes a toothed portion 61, which includes a plurality of teeth and is meshed with the driving side gear 70. A notched portion 62 is formed in a predetermined axial extent (generally the right half extent in FIG. 5A in the present case) of a predetermined outer peripheral part of the driven side cylindrical gear 60. As shown in FIG. 5B, the notched portion 62 is in a form of an arcuate recess, which is recessed in the outer peripheral part of the driven side cylindrical gear 60 toward the rotational axis (the center) of the driven side cylindrical gear 60. A bottom surface of the notched portion 62 forms an arcuate surface 62a.

A small diameter portion is provided in a base of the shaft portion 46, in which the driven side cylindrical gear 60 is formed. As shown in FIG. 2, the small diameter portion forms a support end 45a, which is rotatably supported by the air conditioning case 11.

The through hole 46a of the shaft portion 46 extends in the driven side cylindrical gear 60 and opens in the right end of the driven side cylindrical gear 60 in FIG. 5A. An inner diameter of the through hole 46a is slightly larger than an outer diameter of the shaft portion 36 of the door shaft 35, so that the shaft portion 36 can be coaxially and freely movably received in the shaft portion 46.

The driven side cylindrical gear 50 is configured in such a manner that a diameter of an addendum circle of the driven side cylindrical gear 50 is smaller than the inner diameter of the through hole 46a, so that the shaft portion 36, in which the driven side cylindrical gear 50 is formed integrally, can be received in the through hole 46a from the right side in FIG. 5A. Therefore, as shown in FIG. 2, the driven side cylindrical gear 50 can coaxially project from the driven side cylindrical gear 60, which has a radius of an addendum circle that is different from that of the driven side cylindrical gear 50, on the right side thereof in FIG. 2.

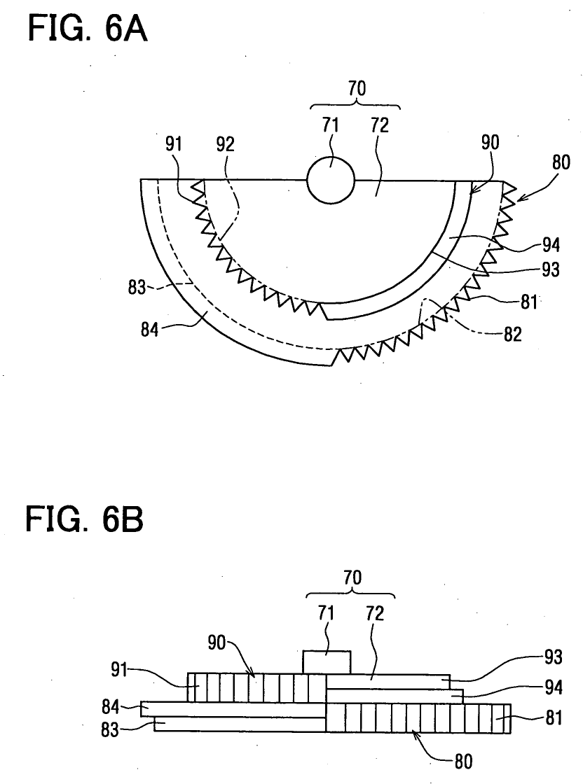

FIGS. 6A and 6B show the driving side gear 70. More specifically, FIG. 6A is a plan view of the driving side gear 70, and FIG. 6B is a bottom view of the driving side gear 70.

As shown in FIG. 6A, the driving side gear 70 is a gear member made of a resin material (polypropylene in the present case). The driving side gear 70 integrally includes a rotatable shaft 71 and a fan-shaped portion 72. The rotatable shaft 71 is connected to an output shaft of the servomotor 100, and the fan-shaped portion 72 extends about the rotatable shaft 71 in a form of a fan (a semicircular shape in the present case).

As shown in FIGS. 6A and 6B, the fan-shaped portion 72 of the driving side gear 70 includes a first door side section 80 and a second door side section 90. The first door side section 80 corresponds to the first slide door 30. The second door side section 90 is stepped from the first door side section 80 and corresponds to the second slide door 40. Each section 80, 90 includes a toothed portion 81, 91 and a rib portion 84, 94. The toothed portion 81, 91, which includes a plurality of teeth, is meshed with the toothed portion 51, 61 of the corresponding driven side cylindrical gear 50, 60. The rib portion 84, 94 is fittable to, i.e., is engageable to the notched portion 52, 62 of the corresponding driven side cylindrical gear 50, 60.

The toothed portion 81 is formed in the right half of the first door side section 80 in FIG. 6A, and the rib portion 84 is formed in the left half of the first door side section 80 in FIG. 6A. An axial extent of the rib 84 is about one half of that of the section 80 in a thickness direction of the section 80 to correspond with the notched portion 52 of the driven side cylindrical gear 50. A radial extent (a height) of the rib portion 84, which is measured from an arcuate surface 83 that circumferentially extends from an arcuate root surface 82 of the toothed portion 81, is constant. Here, the arcuate surface 83 and the arcuate root surface 82 extend along a common arc.

With the above structure, the rib portion 84 can be fitted along the arcuate surface 52a of the notched portion 52 of the driven side cylindrical gear 50. The arcuate surface 83 of the first door side section 80 extends from the root surface 82. Thus, when the rib portion 84 is fitted to the notched portion 52, the arcuate surface 83 does not interfere with the toothed portion 51 of the adjacent portion (a remaining axial extent of the present invention) of the predetermined outer peripheral part of the corresponding driven side cylindrical gear 50, which is arranged adjacent to the notched portion 52.

The toothed portion 91 is formed in the left half of the second door side section 90 in FIG. 6A, and the rib portion 94 is formed in the right half of the second door side section 90 in FIG. 6A. An axial extent of the rib 94 is about one half of that of the section 90 in a thickness direction of the section 90 to correspond with the notched portion 62 of the driven side cylindrical gear 60. A radial extent (a height) of the rib portion 94, which is measured from an arcuate surface 93 that circumferentially extends from an arcuate root surface 92 of the toothed portion 91, is constant. Here, the arcuate surface 93 and the arcuate root surface 92 extend along a common arc.

With the above structure, the rib portion 94 can be fitted along the arcuate surface 62a of the notched portion 62 of the driven side cylindrical gear 60. The arcuate surface 93 of the second door side section 90 extends from the root surface 92. Thus, when the rib portion 94 is fitted to the notched portion 62, the arcuate surface 93 does not interfere with the toothed portion 61 of the adjacent portion (a remaining axial extent of the present invention) of the predetermined outer peripheral part of the corresponding driven side cylindrical gear 60, which is arranged adjacent to the notched portion 62.

The first and second slide doors 30, 40, the door shafts 35, 45, the driving side gear 70 and the servomotor 100 are assembled in a manner shown in FIG. 2. Thus, when the toothed portion 81 of the driving side gear 70 is meshed with the toothed portion 51 of the driven side cylindrical gear 50, the outputted drive force of the servomotor 100 is transmitted to slide the first slide door 30. In contrast, when the toothed portion 91 of the driving side gear 70 is meshed with the toothed portion 61 of the driven side cylindrical gear 60, the outputted drive force of the servomotor 100 is transmitted to slide the second slide door 40.

As discussed above, the driven side cylindrical gear 50 is formed integrally in the shaft portion 36, and the gear 37 is formed integrally in the shaft portion 36. Furthermore, the rack portion 32 of the first slide door 30 is meshed with the gear 37. The shaft portion 36, the gear 37 and the rack portion 32 serve as a link means for conducting the rotational force of the driven side cylindrical gear 50 to the corresponding first slide door 30. Also, as discussed above, the driven side cylindrical gear 60 is formed integrally in the shaft portion 46, and the gear 47 is formed integrally in the shaft portion 46. Furthermore, the rack portion 42 of the second slide door 40 is meshed with the gear 37. The shaft portion 46, the gear 47 and the rack portion 42 serve as another link means for conducting the rotational force of the driven side cylindrical gear 60 to the corresponding second slide door 40.

Next, operation of the vehicle air conditioning system according to the embodiment will be described.

As is known in the art, the vehicle air conditioning system includes an electronic control unit (not shown). The control unit receives manipulation signals outputted from various manipulation members (e.g., switches) provided in an air conditioning manipulation panel and sensor signals outputted from various sensors. The drive means of the air mix door 16 and the servomotor 100 are driven based on corresponding output signals of the control unit to control the position of each door 16, 30, 40.

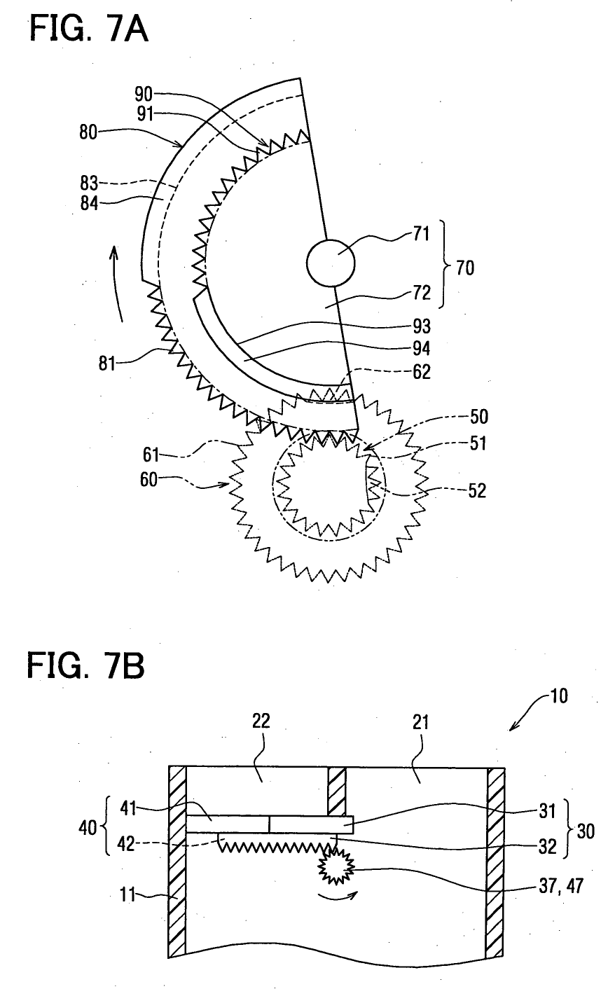

When the driving side gear 70 is rotated by the servomotor 100 in the right direction (the clockwise direction as viewed from the air conditioning case 11 side) in FIG. 7A, the first door side section 80 of the drive gear 70 is operated in such a manner that the toothed portion 81 of the first door side section 80 is meshed with the toothed portion 51 of the driven side cylindrical gear 50 of the door shaft 35 to rotate the driven side cylindrical gear 50 in the left direction in FIG. 7A.

This rotation is transmitted to the rack portion 32 of the first slide door 30 through the shaft portion 36 and the gear 37 of the door shaft 35. As shown in FIG. 7B, the first slide door 30 is slid in the left direction in FIG. 7B to open the face side opening 21 and to close the foot side opening 22, so that the air conditioning system is operated in a face side discharge mode.

At this time, as shown in FIG. 7A, the second door side section 90 of the driving side gear 70 is fitted to the notched portion 62 of the driven side cylindrical gear 60 of the door shaft 45, so that the driven side cylindrical gear 60 is fixed to limit further rotation of the driven side cylindrical gear 60. The arcuate surface 93 of the second door side section 90, which is adjacent to the rib portion 94, does not interfere with the toothed portion 61 of the driven side cylindrical gear 60, so that the rib portion 94 can move in the notched portion 62 while maintaining the fixed state of the driven side cylindrical gear 60.

In this way, the second slide door 40 is fixed to the position of FIG. 7B, so that the second slide door 40 closes the foot side opening 22 in cooperation with the first slide door 30.

In the face side discharge mode, the low temperature air is mainly required in many cases. When a maximum cooling state of the air conditioning system is set, the air mix door 16 is driven to a position, which is indicated by a left side dot-dot dash line in FIG. 1, so that the low temperature air bypass passage 15 is fully opened.

Therefore, in this state, the air blown by the blower unit (not shown) is supplied from the air flow inlet 14 into the air conditioning unit 10 and is cooled first by the evaporator 12 to provide the low temperature air. Then, this low temperature air passes through the low temperature air bypass passage 15 because of the current position of the air mix door 16 and is supplied to the face side opening 21 through the low temperature air/high temperature air mixing space 20. Then, the low temperature air is supplied from the face side opening 21 to the rear seat face side discharge opening through the face side duct (not shown) and is discharged from the rear seat face side discharge opening to the upper half body of the passenger in the rear seat of the passenger compartment.

When the air mix door 16 is rotated from the maximum cooling position toward a maximum heating position, a degree of opening of the low temperature air bypass passage 15 is decreased, and the high temperature air, which is heated by the heater core 13, can be supplied to the low temperature air/high temperature air mixing space 20 to adjust the flow ratio between the low temperature air supplied from the low temperature air bypass passage 15 and the high temperature air (warm air) supplied from the heater core 13. In this way, the temperature of the discharged air in the face side discharge mode can be freely adjusted.

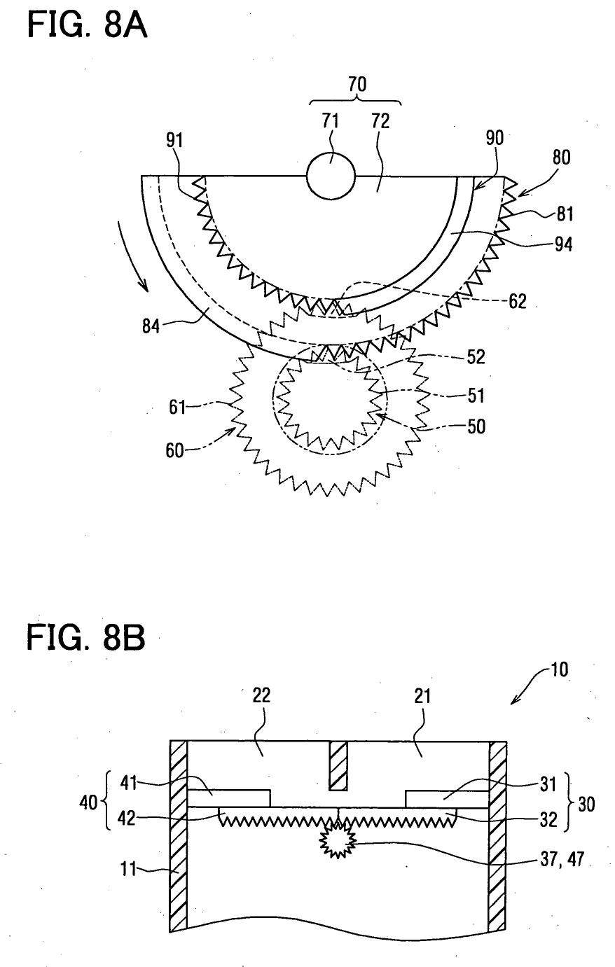

Next, when the driving side gear 70 is rotated from the state shown in FIG. 7A generally to the center portion in the left direction (the counter-clockwise direction as seen from the air conditioning case 11), the first door side section 80 of the driving side gear 70 is operated in such a manner that the engagement between the toothed portion 81 and the toothed portion 51 of the driven side cylindrical gear 50 of the door shaft 35 is released, and the rotation of the driven side cylindrical gear 50 is stopped, as shown in FIG. 8A. Furthermore, the rib 84 is fitted to, more specifically, begins to be fitted to the notched portion 52 of the driven side cylindrical gear 50 of the door shaft 35, and the driven side cylindrical gear 50 is fixed at the rotation stop position.

The rotation of the driven side cylindrical gear 50 from the position of FIG. 7A to the position of FIG. 8A is transmitted to the rack portion 32 of the first slide door 30 through the shaft portion 36 and the gear 37 of the door shaft 35. Thus, as shown in FIG. 8B, the first slide door 30 is slid in the right direction in FIG. 8B to open the right half of the foot side opening 22 and to close the right half of the face side opening 21.

At this time, as shown in FIG. 8A, the end of the rib portion 94 of the second door side section 90 of the driving side gear 70 is still fitted to the notched portion 62 of the driven side cylindrical gear 60 of the door shaft 45, so that the driven side cylindrical gear 60 is fixed to disallow the rotation of the driven side cylindrical gear 60 (the driven side cylindrical gear 60 being in the state right before initiation of the rotation). Thus, as shown in FIG. 8B, the second slide door 40 is held in the state where the left half of the foot side opening 22 is closed.

In this way, the left half of the face side opening 21 and the right half of the foot side opening 22 are opened, so that the air conditioning system is operated in a bi-level discharge mode.

At this time, the air mix door 16 is placed in an intermediate position (e.g., the position indicated by the solid line in FIG. 1), which is between the maximum cooling position and the maximum heating position.

In this state, the air blown by the blower unit (not shown) is supplied from the air flow inlet 14 into the air conditioning unit 10 and is cooled by the evaporator 12 to provide the low temperature air. Then, this low temperature air is divided into an air flow, which passes the low temperature air bypass passage 15, and an air flow, which is reheated by the heater core 13.

In the low temperature air/high temperature air mixing space 20, the high temperature air (the warm air), which is heater by the heater core 13, is mixed with the low temperature air, which is supplied from the low temperature air bypass passage 15. Thereafter, the mixed air is supplied to the face side opening 21 and the foot side opening 22. The low temperature air, which is supplied from the low temperature air bypass passage 15, tends to flow to the face side opening 21. In contrast, the high temperature air, which is supplied through the heater core 13, tends to flow to the foot side opening 22. However, the adjoining sides of the openings 21, 22, which are adjacent to each other, are opened, so that development of a significant temperature difference between the air supplied to the opening 21 and the air supplied to the opening 22 is less likely to occur.

As a result, the temperature of the discharged air, which is discharged from the face side opening 21 toward the upper half body of the passenger in the rear seat, is slightly lower than the temperature of the discharged air, which is discharged from the foot side opening 22 toward the feet of the passenger in the rear seat. Thus, an increase in the temperature difference between the discharged air from the face side opening 21 and the discharged air from the foot side opening 22 is limited, and the comfortable temperature distribution, which causes cooling of the head of the passenger and heating of the feet of the passenger, can be achieved.

Next, when the driving side gear 70 is rotated from the state shown in FIG. 8A in the left direction (the counter-clock wise direction as seen from the air conditioning case 11), the first door side section 80 of the driving side gear 70 is operated in such a manner that the engagement between the rib portion 84 and the notched portion 52 of the driven side cylindrical gear 50 of the door shaft 35 is maintained, and the driven side cylindrical gear 50 is fixed to disallow the rotation of the driven side cylindrical gear 50. The arcuate surface 83 of the first door side section 80, which is adjacent to the rib portion 84, does not interfere with the toothed portion 51 of the driven side cylindrical gear 50, so that the rib portion 84 can move in the notched portion 52 while maintaining the fixed state of the driven side cylindrical gear 50.

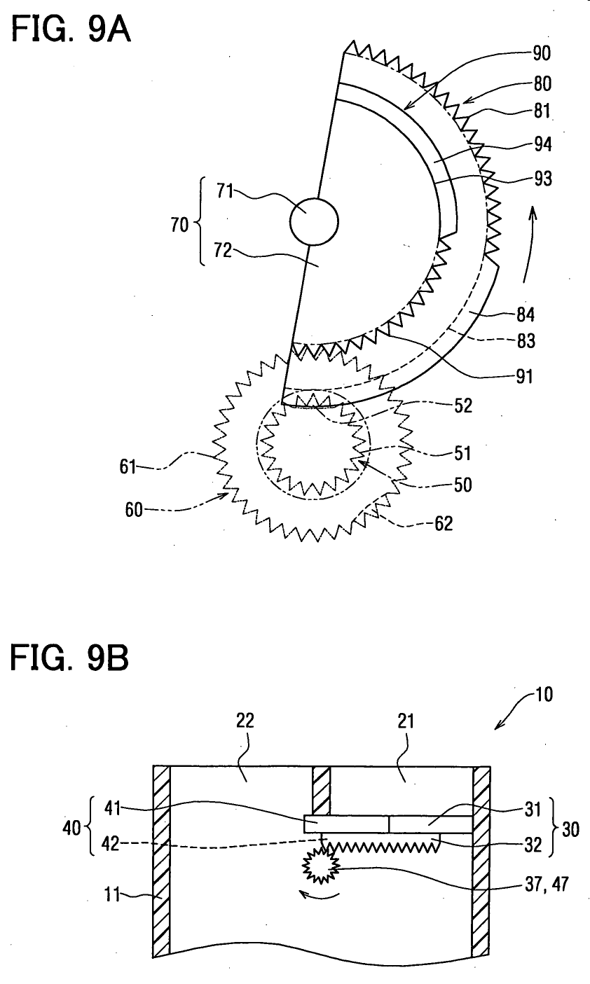

In this way, the first slide door 30 is fixed to the position of FIG. 9B, so that generally the right half of the face side opening 21 in FIG. 9B is closed.

At this time, the second door side section 90 of the driving side gear 70 is meshed with the toothed portion 61 of the driven side cylindrical gear 60 of the door shaft 45 to rotate the driven side cylindrical gear 60 in the right direction in FIG. 9A.

This rotation is transmitted to the rack portion 42 of the second slide door 40 through the shaft portion 46 and the gear 47 of the door shaft 45. As shown in FIG. 9B, the second slide door 40 is slid in the right direction in FIG. 9B to open the foot side opening 22 and to close the face side opening 21, so that the air conditioning system is operated in a foot side discharge mode.

In the foot side discharge mode, the high temperature air (the warm air) is mainly required in many cases. When a maximum heating state of the air conditioning system is set, the air mix door 16 is driven to a position, which is indicated by a right side dot-dot dash line in FIG. 1, so that the low temperature air bypass passage 15 is fully closed.

Therefore, in this state, the air blown by the blower unit (not shown) is supplied from the air flow inlet 14 into the air conditioning unit 10 and is cooled first by the evaporator 12 to provide the low temperature air. Then, this low temperature air is reheated by the heater core 13 because of the current position of the air mix door 16 and is supplied to the foot side opening 22 through the low temperature air/high temperature air mixing space 20.

The high temperature air, which is supplied to the foot side opening 22, is discharged toward the feet of the passenger in the rear seat of the passenger compartment through the foot side duct and the foot side discharge opening (not shown).

When the air mix door 16 is rotated from the maximum heating position toward the maximum cooling position, the flow rate of the air, which passes the heater core 13, is reduced, and the low temperature air bypass passage 15 is opened to supply the low temperature air, which has bypassed the heater core 13, from the low temperature air bypass passage 15 into the low temperature air/high temperature air mixing space 20 to adjust the flow ratio between the low temperature air supplied from the low temperature air bypass passage 15 and the high temperature air supplied from the heater core 13. In this way, the temperature of the discharged air in the foot side discharge mode can be freely adjusted.

According to the above described structure and operation, the operation patter (operation arrangement) of the first slide door 30, which includes the toothed portion 81 and the rib portion 84, is set in the first door side section 80 of the driving side gear 70, and the operation pattern (operation arrangement) of the second slide door 40, which includes the toothed portion 91 and the rib portion 94, is set in the second door side section 90. Upon movement of the driving side gear 70, the driven side cylindrical gears 50, 60 are respectively rotated according to the corresponding set pattern to individually slide the first slide door 30 and the second slide door 40.

That is, the first slide door 30 and the second slide door 40 can be individually slid by the servomotor 100, which is the common drive means. Since it is not required to provide multiple servomotors to the multiple slide doors 30, 40, respectively, an increase in the manufacturing costs can be advantageously limited.

The notched portion 52, 62 of each driven side gear 50, 60 is provided to the corresponding axial extent of the driven side cylindrical gear 50, 60, and the toothed portion 51, 61 is left in the remaining axial extent of the driven side cylindrical gear 50, 60. Furthermore, in each of the first and second gear side sections 80, 90 of the driving side gear 70, the portion, which is circumferentially arranged adjacent to the corresponding rib 84, 94, is formed as the arcuate surface 83, 93, which does not interfere with the toothed portion 51, 61 left in the remaining axial extent of the corresponding driven side cylindrical gear 50, 60.

In this way, even in the notched portion forming outer peripheral part, which forms the notched portion 52, 62, of each driven side cylindrical gear 50, 60, the corresponding toothed portion 81, 91 of the driven side gear 70 can be meshed with the driven side cylindrical gear 50, 60 to rotate the driven side cylindrical gear 50, 60. That is, regardless of the presence of the notched portion 52, 62, the driven side cylindrical gear 50, 60 can be meshed with the toothed portion 81, 91 of the driving side gear 70.

Furthermore, when the rib portion 84, 94 of the driving side gear 70 is fitted to the corresponding notched portion 52, 62, the toothed portion 81, 91 of the driving side gear 70 is meshed with the teeth of the toothed portion 51, 61, which are provided in the remaining axial extent of the driven side cylindrical gear 50, 60. Thus, in this state, when the driving side gear 70 is rotated to remove the rib portion 84, 94 of the driving side gear 70 from the notched portion 52, 62, the driven side cylindrical gear 50, 60 can be reliably returned to the rotating state from the fixed state.

Furthermore, in the driving side gear 70, each toothed portion 81, 91 is formed in the arcuate root surface 82, 92, and each rib portion 84, 94 is formed to have the constant radial height from the arcuate surface 83, 93, which is coaxial with the arcuate root surface 82, 92. In each driven side cylindrical gear 50, 60, the notched portion 52, 62 is in the form of the arcuate recess, which is recessed toward the rotational axis of the driven side cylindrical gear 50, 60 to correspond with the rib 84, 94 of the driving side gear 70.

Thus, it is possible to limit inadvertent displacement of the driven side cylindrical gear 50, 60 in the fixed state of the driven side cylindrical gear 50, 60 where the rib portion 84, 94, which has the constant radial height that correspond to the arcuate notched portion 52, 62, is fitted to the notched portion 52, 62.

As discussed above, the outputted drive force of the servomotor 100 is transmitted from the driving side gear 70, which is directly connected to the output end of the servomotor 100, to the first slide door 30 through the following path: the first door side section 80 of the driving side gear 70; the driven side cylindrical gear 50; the door shaft 35 having the shaft portion 36 and the gear 37; the rack portion 32; and the first slide door 30 (the door portion 31).

Furthermore, the outputted drive force of the servomotor 100 is transmitted from the driving side gear 70 to the second slide door 40 through the following path: the second door side section 90 of the driving side gear 70; the driven side cylindrical gear 60; the door shaft 45 having the shaft portion 46 and the gear 47; the rack portion 42; and the second slide door 40 (the door portion 41).

That is, in the present embodiment, the servomotor 100 serves as the single drive means of the present invention, and the air conditioning system includes the multiple drive force transmission paths, which correspond to the multiple slide doors 30, 40, respectively.

The drive force transmission path (a first drive force transmission path) to the first slide door 30 includes the driving side gear 70, the driven side cylindrical gear 50, the door shaft 35 and the rack portion 32. The drive force transmission path (a second drive force transmission path) to the second slide door 40 includes the driving side gear 70, the driven side cylindrical gear 60, the door shaft 45 and the rack portion 42.

In the drive force transmission paths, the driving side gear 70, which is connected to and is driven by the servomotor 100, serves as a driving side link means of the present invention.

The arrangement, which includes the driven side cylindrical gear 50, the door shaft 35 and the rack portion 32, serves as a driven side link means of the present invention. Also, the arrangement, which includes the driven side gear 60, the door shaft 45 and the rack portion 42, serves as another driven side link means of the present invention.

The first door side section 80 and the second door side section 90 of the driving side gear 70 serve as multiple drive force transmitting portions of the present invention, which transmit the drive force to the multiple driven side link means, respectively.

In this way, when the driving side gear 70, which is connected to the servomotor (the single drive means) 100, is driven, the first and second door side sections (the multiple drive force transmitting portions of the driving side gear 70) 80, 90 respectively drive the multiple driven side link means (the first driven side link means, which corresponds to the first slide door 30, and the second driven side link means, which corresponds to the second slide door 40) according to the operation patters made by the corresponding toothed portion and the rib portion, so that the first and second slide doors 30, 40 are slid to the desired positions, respectively.

In this way, the servomotor 100, which is the single common drive means, can be used to individually slide the multiple slide doors 30, 40 through the driving side link means and the multiple driven side link means. Therefore, since it is not required to provide multiple servomotors to the multiple slide doors 30, 40, respectively, an increase in the manufacturing costs can be advantageously limited.

Furthermore, the setting of the operation patterns of the first and second slide door side sections 80, 90, which correspond to the multiple drive force transmitting portions, can be easily carried out by the toothed portions (the multi-step gears) 81, 91, which are formed on the arc (the arcuate surface) 82, 83 and the arc (the arcuate surface) 92, 93 of the driving side gear 70, which have different diameters.

That is, when the servomotor 100 is driven, the first and second slide door side sections (the multiple drive force transmitting portions) 80, 90 of the driving side gear 70 drive the multiple driven side link means at the predetermined timing according to the operation patters formed on the multi-step arcuate surfaces. Thus, the slide doors 30, 40 can be easily slid at the desired timing.

Furthermore, the face side opening 21 and the foot side opening 22 correspond to the two adjacent openings of the present invention.

Thus, according to the above operation, the first and second slide doors 30, 40 are slid between the one position (the bi-level discharge mode position) and the other position (the face side discharge mode position or the foot side discharge mode position). In the one position (the bi-level discharge mode position), the first slide door 30 and the second slide door 40 are slid in the sliding direction (the adjoining direction of the face side opening 21 and the foot side opening 22) and are thus placed to the outer end of the face side opening 21 and the outer end of the foot side opening 22, respectively, so that both of the face side opening 21 and the foot side opening 22 are half opened. In the other position (the face side discharge mode position or the foot side discharge mode position), the first slide door 30 and the second slide door 40 are slid in the sliding direction and are thus placed to the corresponding one of the face side opening 21 and the foot side opening 22 to fully close the one of the face side opening 21 and the foot side opening 22 and to fully open the other one of the face side opening 21 and the foot side opening 22.

The width of each of the first and second slide doors 30, 40 measured in the sliding direction is smaller than the width of each of the face side and foot side openings 21, 22 measured in the sliding direction.

In this way, at the time of fully opening one of the face side and foot side openings 21, 22, the first and second slide doors 30, 40 are driven to fully open the one of the face side and foot side openings 21, 22 and to fully close the other one of the face side and foot side openings 21, 22 in easy way.

Furthermore, at the time of half opening each of the face side opening 21 and the foot side opening 22, the inner end side of the face side opening 21 and the inner end side of the foot side opening 22 are opened by the first and second slide doors 30, 40, respectively.

As a result, at the time of the bi-level mode where both of the face side opening 21 and the foot side opening 22 are half opened, it is easy to limit the excessive increase in the difference between the temperature of the air, which passes the face side opening 21, and the temperature of the air, which passes the foot side opening 22.

The present invention is not limited to the above embodiment. Specifically, the above embodiment can be modified as follows.

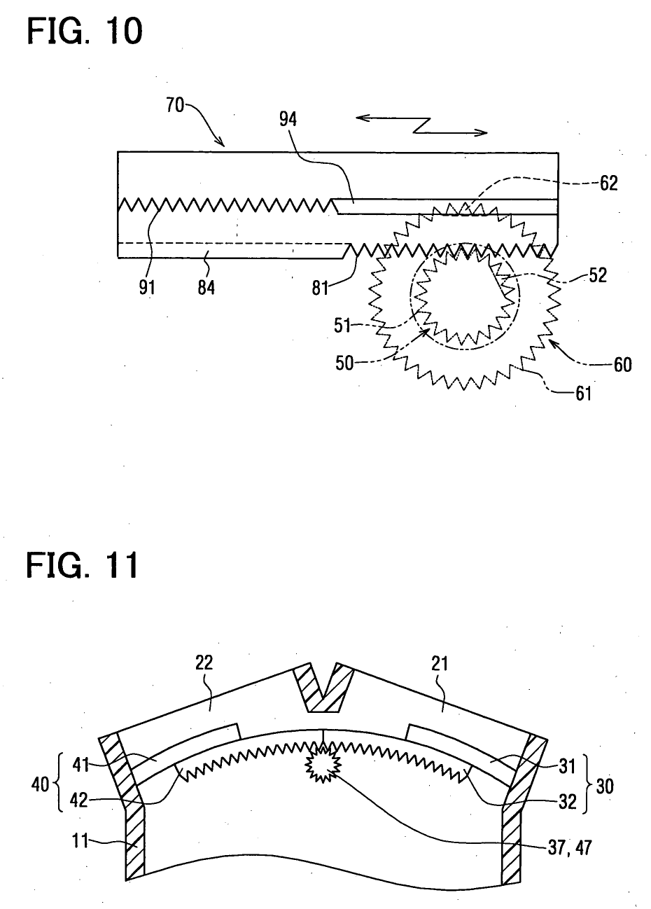

In the above embodiment, the driving side gear 70 is the fan shaped gear. However, the present invention is not limited to this. For example, as shown in FIG. 10, each slide door operation pattern, which includes the toothed portion 81, 91 and the rib portion 84, 94, may be formed in a linear gear (a rack) and may be driven by a linear type servo-actuator.

Furthermore, in the above embodiment, the driving side gear 70 is formed as the integral gear, which integrally includes the first door side section 80 and the second door side section 90. However, the first door side section 80 and the second door side section 90 may be formed in separate bodies (two gear bodies), respectively.

Furthermore, in the above embodiment, the first and second slide doors 30, 40 are linearly slid. However, the first and second slide doors 30, 40 are not required to be linearly slid. For example, as shown in FIG. 11, there may be alternatively provided the slide doors 30, 40, each of which includes a curved door portion 31, 41 provided with a curved gear 32, 42. In this way, each slide door 30, 40 is arcuately slid.

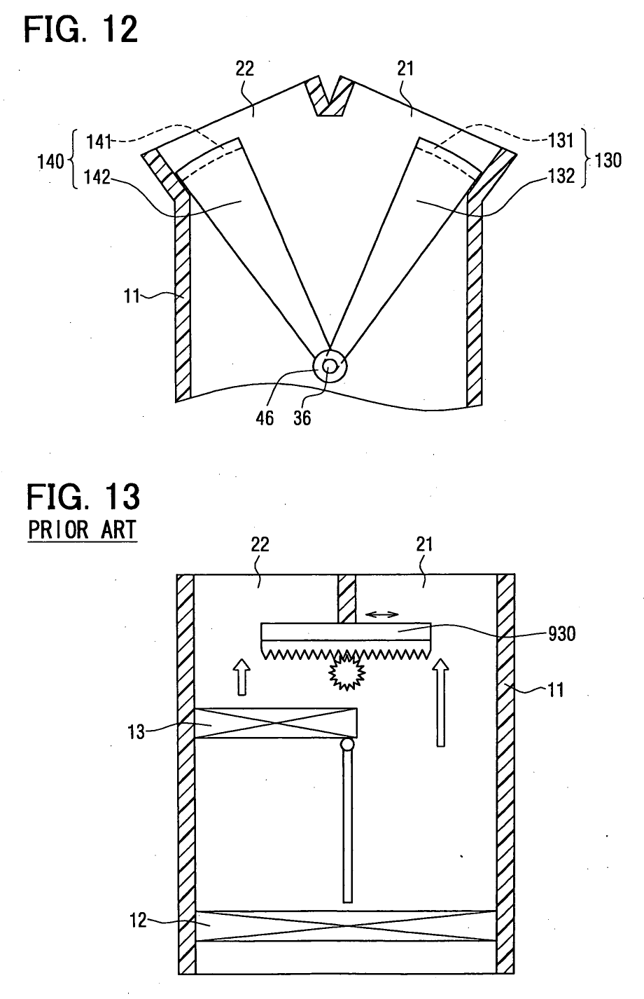

The slide doors 30, 40, each of which arcuately slid, are not required to be driven by the rack and the gear. For example, as shown in FIG. 12, there may be alternatively provided rotary type slide doors 130, 140, each of which is rotated together with the corresponding shaft portion 36, 46 of the above embodiment. In this case, the shaft portions 36, 46 and fan shaped end plate portions 132, 142, which are provided in the ends of the door portions 131, 141 of the slide doors 130, 140, form two link means.

Furthermore, in the above embodiment, the coaxial cylindrical gears 60, 70 are used as the multiple driven side link means, and the door shafts 35, 45 are rotated about the common rotational axis. However, the present invention is not limited this. For example, driven side gears, which are respectively engaged (meshed) with the drive force transmitting portions of the driving side link means and respectively have different rotational axes, can be used as the multiple driven side link means of the present invention.

Furthermore, in the above embodiment, the two slide doors are provided. However, three or more slide doors may be provided.

In the above embodiment, the present invention is applied to the discharge mode doors of the rear air conditioning unit 10. However, the present invention is not limited to this. The present invention is also equally applicable to discharge mode doors of a front air conditioning unit and can be also applicable to any other slide doors of an air passage switching portion.

For example, the present invention can be effectively applied to a case where two adjacent openings are formed as a high temperature air outlet and a low temperature air outlet before mixing of the air flows.

In this way, the slide type air mix doors may be made of multiple slide doors, which are driven by the common drive means.

At this time, when the outlets are opened, the adjoining sides of the outlets can be opened. Thus, it is easy to mix the air flows, which have respectively passed the two adjacent outlets and exhibit the temperature difference therebetween.

Additional advantages and modifications will readily occur to those skilled in the art. The invention in its broader terms is therefore not limited to the specific details, representative apparatus, and illustrative examples shown and described.

1. A vehicle air conditioning system comprising:
a case that defines an air passage therein and includes a plurality of openings for conducting air;
a plurality of slide doors that open and close the plurality of openings;
a plurality of driven side cylindrical gears that have a common rotational axis and are provided to the plurality of slide doors, respectively, wherein each of the plurality of driven side cylindrical gears includes a notched portion in a predetermined outer peripheral part thereof;
a plurality of link means, each of which transmits rotation of a corresponding one of the plurality of driven side cylindrical gears to a corresponding one of the plurality of slide doors;
a driving side gear that includes a plurality of sections, which correspond to the plurality of driven side cylindrical gears, respectively, wherein each of the plurality of sections includes:
a toothed portion that is meshed with the toothed portion of the corresponding one of the plurality of driven side cylindrical gears; and
a rib portion that is engageable with the notched portion of the corresponding one of the plurality of driven side cylindrical gears; and
a drive means for driving the driving side gear.

2. The vehicle air conditioning system according to claim 1, wherein:
the notched portion of each driven side cylindrical gear is provided in a predetermined axial extent of the predetermined outer peripheral part of the driven side cylindrical gear; and
the toothed portion of each driven side cylindrical gear exists in a remaining axial extent of the predetermined outer peripheral part of the driven side cylindrical gear; and
a corresponding portion of each section of the driving side gear, which corresponds to the remaining axial extent of the corresponding one of the plurality of driven side cylinder gear and is adjacent to the rib portion of the section, does not interfere with the toothed portion provided in the remaining axial extent of the corresponding one of the plurality of driven side cylinder gears.

3. The vehicle air conditioning system according to claim 1, wherein:
the toothed portion of each section of the driving side gear is formed in a corresponding arcuate surface of the section of the driving side gear;
the rib portion of each section of the driving side gear is configured to have a constant height from the corresponding arcuate surface of the section; and
the notched portion of each driven side cylindrical gear is in a form of an arcuate recess, which is recessed toward the rotational axis in conformity with a corresponding one of the rib portions.

4. The vehicle air conditioning system according to claim 1, wherein:
each of the plurality of link means includes:
a rack that is provided in the corresponding one of the plurality of slide doors;
a gear that is meshed with the rack of the link means; and
a shaft member, wherein the gear of the link means is provided at one axial end side of the shaft member, and a corresponding one of the plurality of driven side cylindrical gears is provided at the other axial side of the shaft member; and
the shaft members of the plurality of link means are rotatable relative to each other and are coaxially arranged one after another in a radial direction.

5. The vehicle air conditioning system according to claim 4, wherein a diameter of an addendum circle of the driven side cylindrical gear, which is provided to one of the shaft members, is smaller than an inner diameter of an adjacent outer one of the shaft members.

6. The vehicle air conditioning system according to claim 1, wherein:
the plurality of openings of the case includes:
a face side opening that conducts air to be discharged toward a head side of a passenger in a passenger compartment of a vehicle; and
a foot side opening that conducts air to be discharged toward a foot side of the passenger in the passenger compartment of the vehicle; and
the plurality of slide doors opens adjoining sides of the face side and foot side openings at time of simultaneously discharging the air from both of the face side and foot side openings.

7. A vehicle air conditioning system comprising:
a case that defines an air passage therein and includes a plurality of openings for conducting air;
a plurality of slide doors that open and close the plurality of openings;
a single drive means for driving the plurality of slide doors; and
a plurality of drive force transmission paths that transmit a drive force from the single drive means and slide the plurality of slide doors, wherein:
the plurality of drive force transmission paths includes:
a driving side link means that is connected to and is driven by the single drive means; and
a plurality of driven side link means that are driven by the driving side link means and slide the plurality of slide doors, respectively;
the driving side link means includes a plurality of drive force transmitting portions, which transmit the drive force to the plurality of driven side link means, respectively; and
when the single drive means is driven, the plurality of drive force transmitting portions drives the plurality of driven side link means, respectively, so that each of the plurality of slide doors is slide to a corresponding position.

8. The vehicle air conditioning system according to claim 7, wherein the driving side link means includes a plurality of stepped gears, each of which includes an arc that has a diameter different from that of any other one of the plurality of stepped gears.

9. The vehicle air conditioning system according to claim 7, wherein when the single drive means is driven, the plurality of drive force transmitting portions drives the plurality of driven side link means, respectively, at predetermined timing and thereby slide the plurality of slide doors at predetermined timing.

10. The vehicle air conditioning system according to claim 7, wherein:
the plurality of openings includes at least two adjacent openings, which are placed one after another in a sliding direction of the plurality of slide doors;
the plurality of slide doors is slid between a first position and a second position;
when the plurality of slide doors is placed in the first position, the slide doors are placed to outer ends of the two adjacent openings, respectively, so that both of the two adjacent openings are partially opened; and
when the plurality of slide doors is placed in the second position, the slide doors are placed to one of the two adjacent openings to fully close the one of the two adjacent openings and to fully open the other one of the two adjacent openings.

11. The vehicle air conditioning system according to claim 10, wherein when the one of the two adjacent openings is fully closed, the one of the two adjacent openings is fully closed by the plurality of slide doors.

12. The vehicle air conditioning system according to claim 10, wherein a width of each of the plurality of slide doors, which is measured in the sliding direction of the plurality of slide doors, is smaller than a width of each of the two adjacent openings, which is measured in the sliding direction of the plurality of slide doors.

13. The vehicle air conditioning system according to claim 10, wherein a temperature of air, which passes one of the two adjacent openings, is lower than a temperature of air, which passes the other one of the two adjacent openings.
